(19) United States
(12) Patent Application Publication
(10) Pub. No.: US 2024/0429839 A1
(43) Pub. Date: Dec. 26, 2024

(54) SYSTEM AND METHOD FOR GENERATING POWER

(71) Applicant: Ian Clague, Bristol (GB)

(72) Inventor: Ian Clague, Bristol (GB)

(21) Appl. No.: 18/684,482

(22) PCT Filed: Aug. 18, 2022
(86) PCT No.: PCT/IB2022/057745

§ 371 Date: Feb. 16, 2024

(30) Foreign Application Priority Data
Aug. 19, 2021 (GB) 2111901.1

(51) Int. Cl. H02N 11/00; F03G 7/10

(52) U.S. Cl. CPC H02N 11/008; F03G 7/10

(57) ABSTRACT

A system for power generation. The system includes a flywheel assembly including matter therein and a chamber arrangement enclosure surrounding the flywheel assembly, wherein the chamber arrangement enclosure is configured to store antimatter therein using magnetic and/or electrostatic fields. Herein the antimatter in the chamber arrangement enclosure is configured to cause rotation of the flywheel assembly, said rotation providing a driving force to the flywheel assembly for generation of power via a turbine connected thereto.

### TECHNICAL FIELD

The present disclosure relates generally to power generation; and more specifically, to systems for generating power using antimatter stored in a chamber arrangement enclosure.

### BACKGROUND

Power generation, or electricity generation is an essential part of modern life. The global power consumption has amounted to approximately 23,398 billion kilowatt hours, or 23,398 terawatt hours in 2018. In order to generate power, various methods have been devised over the years. These methods of power generation are divided into two categories, namely, renewable power generation and non-renewable power generation. Herein, renewable power is obtained from natural resources or processes that are constantly replenished. For example, renewable power generation harnesses power from sun, wind, tidal wave and so forth. In contrary, non-renewable power generation includes power derived from coal, oil, natural gas and nuclear energy and is currently used in abundance because of accessible infrastructure and affordability.

Notably, renewable power generation may be unreliable as they are completely dependent on weather of the particular area where the renewable power generation plant is situated. Furthermore, renewable power generation suffers from low efficiency levels as there is lack of sufficient knowledge to effectively harness the natural resources for consumption. Consequently, non-renewable power generation is employed in abundance and is quite affordable. Moreover, non-renewable power generation is cost effective and easier to produce and use. However, non-renewable resources cannot be replenished. Furthermore, fossil fuels used the non-renewable resources contribute to global warming. Also, certain harmful gases are released when the fossil fuels are burned, such as nitrous oxides, sulphur dioxide, carbon dioxide and so forth. Furthermore, nitrous oxides cause photochemical pollution, sulphur dioxide creates acid rain, and greenhouse gases such as carbon dioxide cause global warming.

Therefore, in light of the foregoing discussion, there exists a need to overcome the aforementioned drawbacks associated with conventional methods for generating power.

### SUMMARY

The present disclosure seeks to provide a system for power generation. The present disclosure also seeks to provide a method for power generation. An aim of the present disclosure is to provide a solution that overcomes at least partially the problems encountered in prior art.

In one aspect, the present disclosure provides a system for power generation, the system comprising
a flywheel assembly comprising matter therein; and
a chamber arrangement enclosure surrounding the flywheel assembly, wherein the chamber arrangement enclosure is configured to store antimatter therein using magnetic and/or electrostatic fields;
   wherein the antimatter in the chamber arrangement enclosure is configured to cause rotation of the flywheel assembly, said rotation providing a driving force to the flywheel assembly for generation of power via a turbine connected thereto.

In another aspect, the present disclosure provides a method of power generation using the aforementioned system.

Embodiments of the present disclosure substantially eliminate or at least partially address the aforementioned problems in the prior art, and enable efficient generation of power.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is an illustration of top view and perspective view of a system for power generation, in accordance with an embodiment of the present disclosure;

FIG. 2 is an illustration of perspective view of the flywheel assembly, in accordance with an embodiment of the present disclosure;

FIG. 3 is a schematic illustration of a tokamak ring-shaped chamber, in accordance with an embodiment of the present disclosure;

FIG. 4 is a schematic illustration of a particle accelerator arrangement, in accordance with an embodiment of the present disclosure;

FIG. 5 is a schematic diagram of an efficient antimass generator for example for use when implementing the system of FIG. 1; and

FIGS. 6, 7, 8, 9, 10, 11 and 12 are schematic illustrations of underlying technical concepts that are relevant to understanding embodiments of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a system for power generation, the system comprising
a flywheel assembly comprising matter therein; and
a chamber arrangement enclosure surrounding the flywheel assembly, wherein the chamber arrangement enclosure is configured to store antimatter therein using magnetic and/or electrostatic fields;
   wherein the antimatter in the chamber arrangement enclosure is configured to cause rotation of the flywheel assembly, said rotation providing a driving force to the flywheel assembly for generation of power via a turbine connected thereto.

The present disclosure provides a system for power generation including a flywheel assembly and a chamber arrangement enclosure. The system as described in the present disclosure comprises antimatter in the chamber arrangement enclosure which is configured to cause rotation of the flywheel assembly, wherein the said rotation provides a driving force to the flywheel assembly for generation of power via a turbine connected thereto. The present disclosure further provides a compact and practical particle accelerator arrangement that can be used for power generation. Notably, the system described herein is suited for efficient generation of power without use of fossil fuels.

Notably, modern physics research has identified that a force of gravitational attraction between two positive masses; however, when one of the two positive masses is replaced by a corresponding antimatter mass, the antimatter mass experiences a repulsion between matter and antimatter. It is this force that is being harnessed to provide driving force to the flywheel assembly. Moreover, the strength of this repulsive gravitational force has been found to be much stronger than Newtonian gravity. This means that a relatively small amount of antimatter provides a large driving force to the flywheel assembly, which consists of positive matter. This large driving force provides a propulsive effect for enabling rotation of the flywheel assembly. Indeed, the repulsive gravitational force has been found to be 10⁴⁵ (ten to the power 45) times more powerful than Newtonian gravity.

A torque applied by the repulsive gravitational force would apply the same torque to all points of the flywheel assembly (which is matter). This torque is additive, so the rotation of the flywheel assembly is pushed in the same direction (for example, anti-clockwise or clockwise) at all points. In such a case, no external supply of energy is provided to the flywheel assembly for maintaining its rotation. This concept can be understood by considering, for example, rotation of a carousel in a playground. If one child pushes on the carousel from the left-hand side, applying torque and causing it to rotate anti-clockwise and another child, pushes from the right-hand side from a position at 180 degrees from the first child but still causing the carousel to rotate in an anti-clockwise direction, the forces applied by the two children do not cancel out. In fact, these two forces reinforce each other and both cause the carousel to rotate in an anti-clockwise direction.

The system comprises a flywheel assembly comprising matter therein. Herein, the flywheel assembly comprises a flywheel, a motor-generator unit, a power converter unit, magnetic bearings and an external inductor. Furthermore, the flywheel is a matter having mass spinning about an axis. Functionally, the flywheel assembly is an energy storage device that stores mechanical energy in the form of kinetic energy before conversion to electrical energy by generator present in the motor-generator unit. Herein, the kinetic energy of the flywheel is given by

Eₖ=½ω²

wherein I is the moment of inertia and ω is angular velocity of the rotating disc of the flywheel arrangement. Furthermore, the moment of inertia is given by the equation

I=∫r²dm

wherein r is radius of the rotating disc in the flywheel arrangement. In the present disclosure, the flywheel arrangement is cylindrical in structure, wherein the moment of inertia is given by

I=½r⁴πaρ

wherein a is cross-sectional area of the rotating disc in the flywheel arrangement and ρ is density of the rotating disc in the flywheel arrangement. Furthermore, the motor-generator unit in the flywheel arrangement are permanent magnet machines. Herein, the motor-generator unit exhibit low rotor losses and low winding inductance. Thereby, rapid energy transfer takes place in the flywheel assembly. Functionally, the motor-generator unit performs absorption and discharge of energy.

Additionally, the power converter unit comprises a three-phase insulated-gate bipolar transistor (IGBT) based pulse-width modulation (PWM) inverter and or rectifier. Herein, the IGBT is a solid-state device with ability to handle voltages up to 6.7 kiloVolts, currents up to 1.2 kiloAmperes and high switching frequencies. Furthermore, the magnetic bearings comprise permanent magnets and electromagnets. Herein, the permanent magnet supports weight of the flywheel by repelling forces, and electromagnets stabilizes the flywheel. The magnetic bearings may be for example, but not limited to, high temperature superconductor (HTS) magnetic bearing, active magnetic bearings (AWB). Herein, the HTS magnetic bearing can place the flywheel automatically without the need of electricity or a positioning control system. Furthermore, HTS magnetic bearing require cryogenic cooling by liquid nitrogen. Moreover, the external inductor is connected in series with the power converter unit in order to reduce total harmonic distortion (THD).

The system comprises chamber arrangement enclosure surrounding the flywheel assembly. The chamber arrangement enclosure is configured to store antimatter therein, using magnetic and/or electrostatic fields. Herein, the chamber arrangement enclosure is a vacuum chamber to reduce friction and energy losses.

Optionally, a weight of the matter in the flywheel assembly corresponds to a negative weight of the antimatter in the chamber arrangement enclosure. Herein, matter and antimatter pairs briefly orient themselves in relation to the mass of the flywheel assembly. Furthermore, flywheel assembly comprises matter which is attracted to the negative weight of the antimatter. Conversely, the chamber arrangement enclosure comprises antimatter which is repelled by the weight of the matter. Thereafter, a negative pressure is created to produce accelerated motion of rotor in the flywheel assembly.

Optionally, the chamber arrangement enclosure is configured to store antimatter therein, for example positrons therein, by using magnetic and/or electrostatic fields. Herein, the term “positron” refers to antimatter part of the electron having an electric charge of +1e and a spin of ½. It will be appreciated that when antimatter is contacted by electrons or matter particles, annihilation occurs generating two photons. Therefore, positrons are to be generated in vacuum conditions and suspended in the chamber arrangement enclosure using magnetic and/or electrostatic fields in a manner that positrons are not contacted by any matter.

Optionally, the antimatter comprises positrons. Optionally, the positrons are produced in copious amounts, using p-doped semiconductor materials. Any suitable semiconductor material that can be p-doped and then be further used to produce a high amount of positrons, is feasible for use. Such semiconductor materials are well-known in the art.

It will be appreciated that a hole in a semiconductor can be thought of as a positron (i.e., an electron-like quasiparticle with charge +e). Quasiparticles mathematically behave like particles which are rare, absent, unstable, or unobserved in free space. A hole responds to electric field as is expected from a positively-charged electron. A hole and an electron can exist in a semiconductor for a relatively long time, depending on details of the semiconductor.

According to Dirac-Milne cosmology, a symmetric matter-antimatter cosmology that is studied in “Gravity, antimatter and the Dirac-Milne universe” by Gabriel Chardin and Giovanni Manfredi, antiparticles have the same gravitational properties as holes in a semiconductor. The matter-antimatter universe is impressively concordant, and has also a simple physical analog with the electron-hole system in the semiconductor.

Optionally, the chamber arrangement enclosure is implemented as a tokamak ring-shaped chamber that is configured to store the antimatter along an annular central magnetic axis of the tokamak ring-shaped chamber. Notably, the tokamak ring-shaped chamber is shaped in the form of a ring or a torus, wherein toroidal field coils are helically wound around the torus to induce a magnetic field along the annular central magnetic axis thereof. Additionally, or alternatively, optionally, the tokamak ring-shaped chamber employs permanent neodymium magnets to suspend the antimatter in the chamber arrangement enclosure. The tokamak ring-shaped chamber provides a high-vacuum (for example, at a vacuum pressure of less than 1×10⁻⁷ milliBar, more optionally less than 1×10⁻⁹ milliBar, achievable using a combination of a roughing pump and a vacuum turbo pump), hermetically sealed chamber for the antimatter, wherein the antimatter continuously spirals around the annular central magnetic axis without touching the walls. Optionally, the walls of the tokamak ring-shaped chamber are in the form of wires which provide electromagnetic containment and guidance. It will be appreciated that said walls are not entirely solid material.

Optionally, the system is enveloped in partial vacuum. A technical effect of this is that such enveloping reduces a rate of annihilation of the positrons.

Optionally, the system further comprises a laser arrangement, a target that is configured to be stimulated by a laser beam generated by the laser arrangement to produce the antimatter, and a deflector arrangement that is configured to guide the antimatter generated at the target into the chamber arrangement. Notably, the laser beam generated by the laser arrangement is directed towards the target, wherein the laser beam ionizes and accelerates electrons, which are driven through the target. Optionally, the laser beam may be a pulsed laser beam or a laser beam having a high intensity. Herein, as the electrons are driven through the target, the electrons interact with nuclei of the target, wherein the nuclei serve as a catalyst to create antimatter. The electrons emit packets of energy, wherein the energy decays into matter and antimatter, following the predictions by Einstein's equation relating to matter and energy (E=mc²). Notably, by concentrating the energy in space and time, the laser beam produces antimatter in a high density. The target may have a thickness in an order of a few millimetres and may be manufactured using Gold Erbium or Tantalum, for example. As the antimatter is generated, the deflector arrangement guides the antimatter into the chamber arrangement enclosure. Optionally, the target is spatially integrated with the tokamak ring-shaped chamber.

In an embodiment, the target further comprises a composite Copper-Gold, Copper-Erbium or Copper-Tantalum structure that is irritated with pulsed laser beams, wherein the composites upon irradiation generate intense laser beams that subsequently excite the Gold, Erbium or Tantalum target to generate antimatter.

Optionally, the target is provided with one or more fluid channels for accommodating a flow of a cooling fluid therethrough for cooling the target. More optionally, the target may be a Gold sheet, an Erbium sheet or a Tantalum sheet that is bonded to a heat sink, wherein the heat sink includes internal fluid channels therein for accommodating a flow of a cooling fluid for cooling the heat sink and its Gold, Erbium or Tantalum sheet. It will be appreciated that when blasted with accelerated particles or laser beams, the target may reach a high temperature, unless cooled by using a cooling fluid as aforementioned. The one or more internal fluid channels for accommodating a flow of cooling fluid reduces an operating temperature of the target, thereby enabling a safe operation thereof.

Optionally, the target is raster scanned by a laser beam or high-energy particle beam over its entire area rather than being maintained on just one area of the target. Beneficially, such raster scanning ensure that thermal dissipation occurs over the entire area of the target, thereby avoiding localized sputtering, evaporation or ablation of the target. This can be achieved by scanning the laser beam or actuating the target, or a mixture of both.

Optionally, the laser arrangement includes one or more Q-switched lasers that are configured to generate light pulses that cause the antimatter to be generated in the target. Notably, the Q-switched laser produces light pulses of high peak power, specifically in an order of gigawatts. The light pulses produced by the one or more Q-switched lasers generally produce light pulses that last a few nanoseconds. Such short operational time allows greater control over the generation of antimatter at the target. It will be appreciated that a Q-switched laser of high intensity may generate a high ratio of antimatter to electrons, possibly approaching a neutral “pair plasma” with equal numbers of antimatter and electrons.

Optionally, the system further comprises a particle accelerator arrangement, a target that is configured to be stimulated by a particle beam generated by the particle accelerator arrangement to produce the antimatter, and a deflector arrangement that is configured to decelerate and guide the antimatter generated at the target into the chamber arrangement enclosure. Herein, a miniaturized version of particle accelerator arrangement is used for the production of antimatter. Notably, the particle accelerator arrangement uses electromagnetic fields to propel charged particles, such as protons or electrons, to very high speeds and energies, and to contain them in well-defined beams. Subsequently, the charged particles are either smashed onto a target or against other particles circulating in an opposite direction, thereby generating beams of electrons, antimatter, protons, and antiprotons interacting with each other or with the simplest nuclei at the highest possible energies, generally hundreds of GeV or more. As the antimatter is generated, the deflector arrangement decelerates and guides the antimatter into the chamber arrangement enclosure. It will be appreciated that electrons are decelerated and guided into the chamber arrangement enclosure in high-vacuum conditions, wherein the target, the deflection arrangement and the interior of the chamber arrangement enclosure needs to be evacuated of air when the particle accelerator arrangement is in operation (for example, a vacuum to 1×10⁻⁸ milliBar is required).

Optionally, the deflector arrangement includes one or more electromagnetic and/or electrostatic lenses for focusing the antimatter generated at the target as an antimatter beam to feed into the chamber arrangement. Notably, the deflector arrangement ensures that the antimatter generated at the target do not contact any matter and are focused as an antimatter beam into the chamber arrangement enclosure to be suspended therein using magnetic and/or electrostatic fields. The electromagnetic lens used herein may be similar in its operation to electromagnetic lenses as used in a conventional scanning electron microscope (SEM). Furthermore, the deflector arrangement is maintained at a potential difference in comparison with the target to draw antimatter away from the target and into the chamber arrangement enclosure. Additionally, optionally, the deflector arrangement may employ permanent neodymium magnets for focusing the antimatter into the chamber arrangement enclosure.

In an embodiment, laser pincers may be used for the production of antimatter. Herein, the laser pincers comprise a first laser and a second laser opposite to the first laser. Furthermore, the first laser and the second laser are fired from the laser pincers at a plastic block. Furthermore, the plastic block comprises crisscrossed channels, wherein the crisscrossed channels are micrometers wide. Subsequently, the crisscrossed channels help to accelerate a cloud of electrons within the plastic block once the first laser and the second laser have shot through the plastic block. Consequently, upon collision of the cloud of electrons from the first laser and the second laser, a large number of gamma rays are produced which produces matter and antimatter. Additionally, the laser pincers utilize magnetic fields to concentrate the antimatter into a focused beam. Consequently, over a distance of at most 50 micrometers, the focused beam may reach an energy of 1 gigaelectronvolt.

In an embodiment, the chamber arrangement enclosure is implemented as a stellarator that is configured to store the antimatter therein. Notably, the stellarator is a device that employs external magnets to confine antimatter therein.

In an embodiment, the chamber arrangement enclosure is implemented as a buffer-gas trap comprising a Penning-Malmberg type electromagnetic trap to store antimatter therein. It will be appreciated that magnetic fields required for operating the chamber arrangement enclosure need to be of considerable strength since the magnetic fields will effectively bear a weight of the vehicle. The buffer-gas trap, is a type of ion-trap that provides an axial electric charge which prevents the positively charged positrons from escaping radially. Specifically, antimatter is confined in a vacuum inside an electrode structure consisting of a stack of hollow, cylindrical metal electrodes. A uniform axial magnetic field inhibits positron motion radially, and voltages imposed on end electrodes prevent axial loss.

Optionally, the target, for example, a Gold, Erbium or Tantalum target is spatially integrated with the buffer-gas trap. Notably, the antimatter generated at the target are consequently transferred to the buffer-gas trap for storage. Beneficially, the buffer-gas trap is a compact and light-weight implementation of the chamber arrangement enclosure and can be used to generate power. Furthermore, the buffer-gas trap slows down an antimatter beam to electron-volt energies and accumulates them in the trap.

Pursuant to the embodiments describing the buffer-gas trap, the present disclosure employs a modified Penning-Malmberg trap as the buffer-gas trap that comprises of a series of cylindrically symmetric electrodes of varying inner diameters. These form three distinct trapping stages with three distinct pressure regions, and confine the antimatter axially by producing electrostatic potentials. The antimatter is confined radially by a static magnetic field produced by one solenoid enclosing the electrodes. The principle of this trap is that the incoming antimatter lose their energy through inelastic collisions with a buffer gas that is introduced in the first stage of the trap. As they cool down, they become trapped in successively deeper potential wells, and progressively lower pressure, until the antimatter is confined on the lowest pressure region of the trap, where the lifetime is longer. It is to be noted that in order to trap the antimatter with a few tens of electron-volt energy, they must lose enough energy so that they do not exit the trap once they are reflected by the end potential barrier. The cooling mechanism employed in this type of traps is the inelastic collisions an antimatter undergoes with the buffer gas.

The chamber arrangement enclosure comprises the antimatter which is configured to cause rotation of the flywheel assembly. Furthermore, the rotation provides a driving force to the flywheel assembly for generation of power via a turbine connected thereto. Herein, antimatter present in the chamber arrangement enclosure repels the flywheel assembly comprising matter. Thereafter, the repulsion causes the flywheel assembly to rotate. Subsequently, the rotation of the flywheel assembly is transferred to the turbine. Herein, the turbine is a generator which comprises a rotor. Thereby, the rotor starts rotating with the same speed as the rotation of the flywheel assembly. Consequently, in accordance with the principle of electromagnetic induction, current starts flowing in the rotor of the turbine.

Therefore, power is generated by converting kinetic energy of the flywheel assembly to electrical energy.

The present disclosure also relates to the method as described above. Various embodiments and variants disclosed above apply mutatis mutandis to the method.

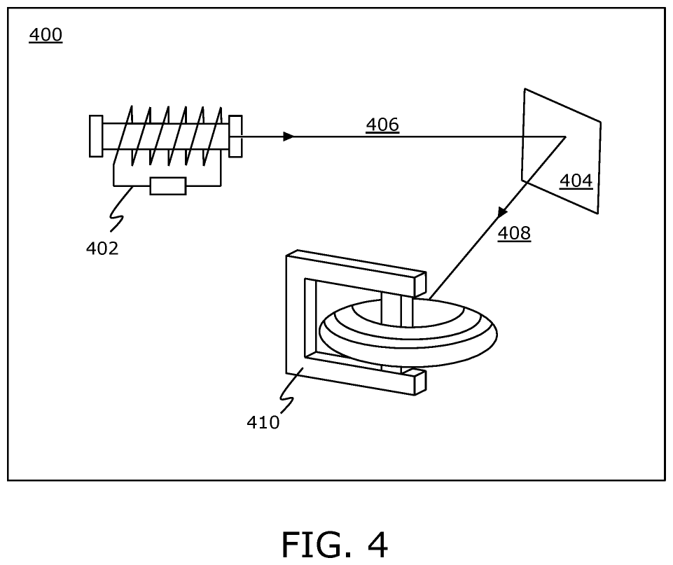

The present disclosure further provides a particle accelerator arrangement as described in detail in FIG. 4.

### DETAILED DESCRIPTION OF THE DRAWINGS

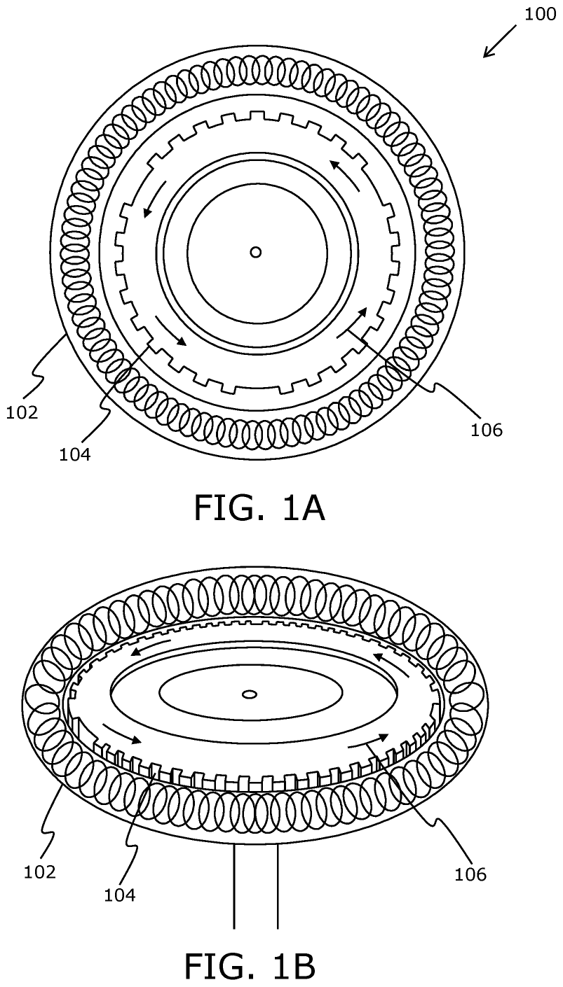

Referring to FIGS. 1A and 1B collectively, illustrated is a top view and perspective view of a system 100 for power generation, in accordance with an embodiment of the present disclosure. Herein, a chamber arrangement enclosure 102 comprises antimatter. A flywheel assembly 104 comprising matter is propelled by the antimatter present in the chamber arrangement enclosure 102 and starts rotation 106.

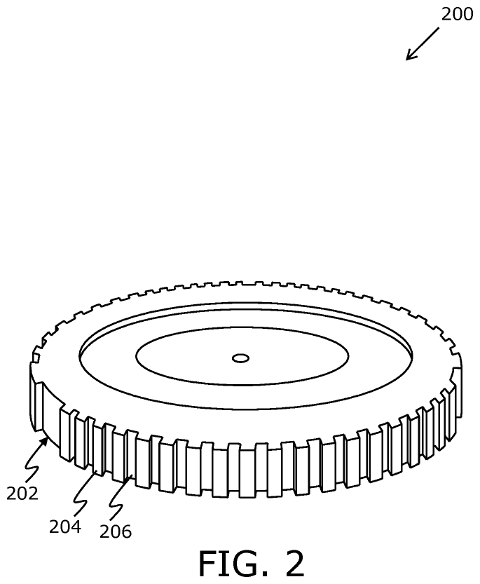

Referring to FIG. 2, illustrated is a perspective view of the flywheel assembly 200, in accordance with an embodiment of the present disclosure. The flywheel assembly 200 comprises a flywheel 202. The flywheel 202 is made of addendum 204 and dedendum 206.

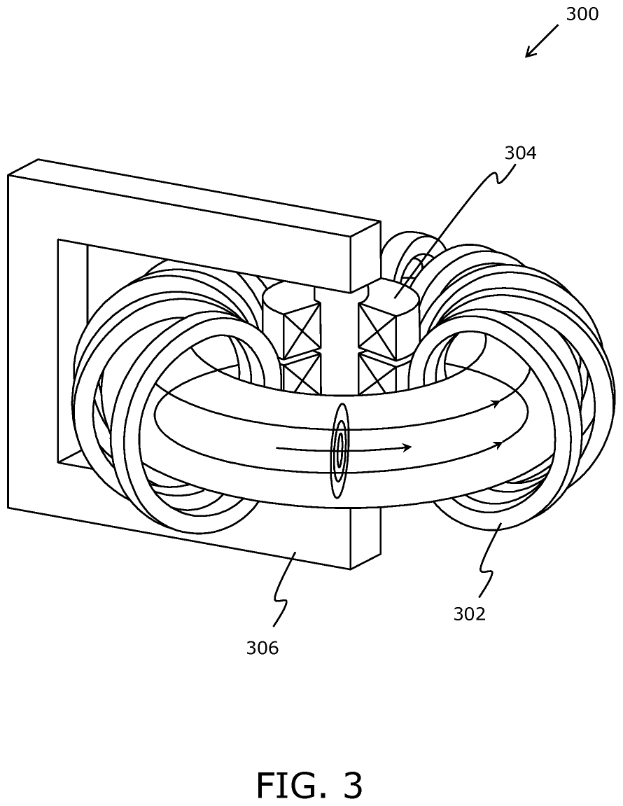

Referring to FIG. 3, there is shown a schematic illustration of a tokamak ring-shaped chamber 300, in accordance with an embodiment of the present disclosure. As shown in FIG. 3, the tokamak ring-shaped chamber 300 is shaped in the form of a ring or a torus, wherein toroidal field coils 302 are helically wound around the torus to induce a magnetic field along the annular central magnetic axis thereof. The tokamak ring-shaped chamber 300 further comprises a primary winding 304 and a transformer yoke 306.

Referring to FIG. 4, there is shown a schematic illustration of a particle accelerator arrangement 400, in accordance with an embodiment of the present disclosure. The particle accelerator arrangement 400 comprises a laser arrangement 402, a target 404 that is configured to be stimulated by a laser beam 406 generated by the laser arrangement to produce the antimatter 408, and a deflector arrangement that is configured to guide the antimatter 408 generated at the target 404 into the chamber arrangement, such as the tokamak ring-shaped chamber 410. The laser arrangement 402 includes one or more Q-switched lasers that are configured to generate light pulses that cause the antimatter 408 to be generated in the target 404. The target 404 may be manufactured using Gold, Erbium or Tantalum, although other heavy elements can alternatively be used.

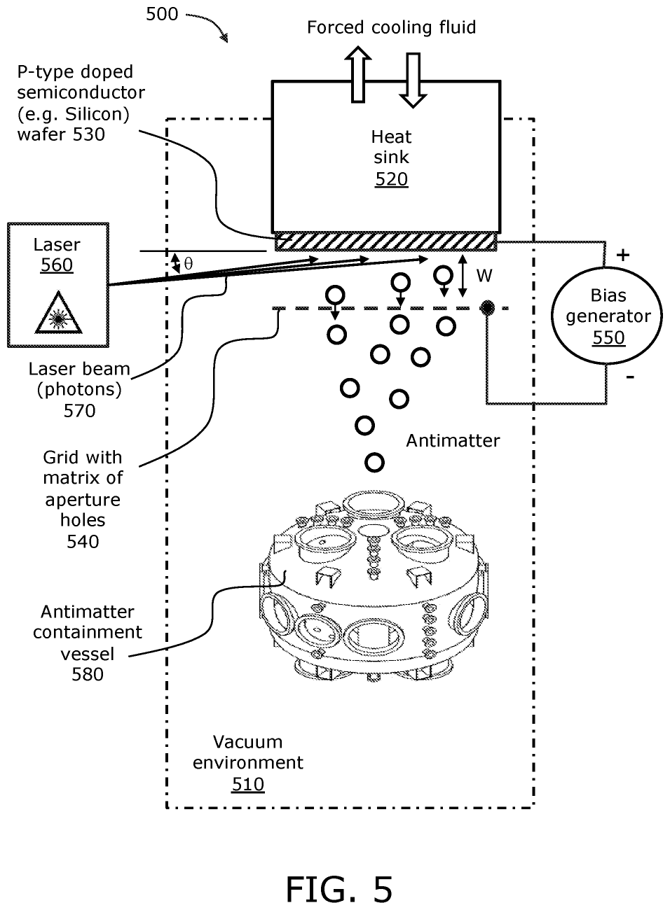

In the foregoing, it will be appreciated that being able to generate antimatter efficiently is an important performance characteristic in embodiments of the present disclosure. In FIG. 5, there is shown a particularly efficient apparatus for generating antimatter, for example for use in the power generation 100, but not limited thereto; the system is indicated generally by 500. The system 500 includes a chamber arrangement enclosure in which a vacuum environment 510 is established when the system 500 is in operation. A vacuum of at least 1×10⁻⁷ milliBar, more optionally 1×10⁻⁹ milliBar is maintained in the vacuum environment 510 by using a combination of one or more roughing pumps and one or more turbo pumps. The vacuum environment 510 houses a heatsink arrangement 520 onto which a semiconductor wafer 530, for example a Silicon wafer, is mounted; the semiconductor wafer 530 is beneficially p-doped Silicon, for example an exposed polished surface of the semiconductor wafer 530 has been ion-implanted or thermally diffused with p-type dopant, for example Boron. Optionally, the semiconductor wafer 530 is of form that is customarily used in Silicon integrated circuit manufacture. The heatsink arrangement 520 is provided with forced fluid cooling fluid to remove heat from the heatsink arrangement 520 received from the semiconductor wafer 530 when the system 500 is in operation. The vacuum environment 510 also includes a grid 540, for example implemented as a metallic mesh with an array of apertures formed therein, that is mounted so that its plane is spatially separated from a plane of the polished surface of the semiconductor wafer 530 by a distance W. Optionally, the grid 540 is fabricated from a metal having a high melting point, for example from Tungsten metal; optionally, the grid 540 is manufactured using electroplating techniques to deposit Tungsten onto a copper substrate, or by using laser cutting ablation to cut apertures into a Tungsten sheet. Although Tungsten is mentioned as a preferred metal to use for manufacturing the grid 540, it will be appreciated that other metals can be alternatively used. The distance W is beneficially in a range of 2 mm to 20 mm. A bias generator 550 is connected between the semiconductor wafer 530 and the grid 540 to maintain the grid 540 at a negative potential relative to the semiconductor wafer 530; an electric field is thereby established at the polished surface of the semiconductor wafer 530 when the system 500 is in operation. The electric field beneficially has an electric field strength E in a range of 0.3 to 1.5 MegaVolts/metre, namely in a range of 0.3 to 1.5 kiloVolts/millimetre. The bias generator 550 is conveniently implemented as a solid-state high-frequency inverter with Wheatstone bridge voltage multiplication at its output. A pulsed laser arrangement 560, for example implemented in a manner of the aforesaid laser arrangement 402, is configured to direct a pulsed laser beam 570 at a shallow angle q, for example less than 10° relative to a plane of the polished surface of the semiconductor wafer 530, towards the polished surface of the semiconductor wafer 530; thus, the pulsed laser beam 570 is directed at the polished surface of the semiconductor wafer 530 in a region between the polished surface and the grid 540. Optionally, the laser beam 570 propagates as an evanescent wave along the polished surface of the semiconductor wafer 530 such that photon energy of the laser beam 570 is tightly bound to the polished surface of the semiconductor wafer 530; such evanescent wave propagation requires the glancing angle q to be a very shallow glancing angle of the laser beam 570 relative to the polished surface of the semiconductor wafer 530, for example at a glancing angle of 1° or less. Optionally, peripheral edges of the semiconductor wafer 530 are polished and mutually parallel so that an optical cavity is formed at the surface of the semiconductor wafer 530 in respect of evanescent light propagation along the surface of the semiconductor wafer 530; such a configuration is particularly efficient at using photons of the laser beam 570 for generating antimatter as very light of the laser beam 570 becomes dissipated at edges of the semiconductor wafer 530. The optical cavity can be formed by scribing and cleaving the semiconductor wafer 510, and then carefully polishing to optical finish cleaved edges of the semiconductor wafer 530. An antimatter containment vessel 580, for example implemented as the aforementioned chamber arrangement enclosure 102, is positioned within the vacuum environment 510 to receive antimatter that have been generated at the polished surface of the semiconductor wafer 530 and that have been drawn away from the semiconductor wafer 530 by the aforesaid electric field and have passed through the apertures of the grid 540.

Next, a method of operating the system 500 will be described. The method includes using the aforesaid one or more roughing pumps and one or more turbo pumps to establish a vacuum in the vacuum environment 510 as described in the foregoing. Moreover, the method includes configuring the bias generator 550 to apply a potential difference between the grid 540 the semiconductor wafer 530, wherein the grid 540 is biased to a negative potential relative to the semiconductor wafer 530. Furthermore, the method includes using the pulsed laser arrangement 560 to generate the laser beam 570; as aforementioned, photons of the laser beam 570 are composite couplets, namely a combination of an electron and an antimatter. The method further includes propagating the laser beam 570 along the polished surface of the semiconductor wafer 530, wherein the photons at least partially impinge into the semiconductor wafer 530, for example by a few nanometres or even micrometres. Electrons of the photons interact with holes provided by p-type doping of the semiconductor wafer 530, wherein the electrons become preferentially absorbed into the semiconductor wafer 540, thereby allowing their corresponding antimatter to be extracted by action of the aforesaid electric field established by the bias generator 550 between the semiconductor wafer 530 and the grid 540. The semiconductor wafer 530 optionally has a p-type doping, for example Boron doping; the p-type doping concentration is selected to provide a sheet resistance at the polished surface of the semiconductor wafer 530 in a range of 0.001˜0.005 Ω-cm, optionally 0.01˜0.09 Ω-cm, optionally 0.1˜0.9 Ω-cm, optionally 1˜10 Ω-cm, and yet more optionally 20˜100 Ω-cm. Higher doping concentrations than aforesaid are optionally used when fabricating the semiconductor wafer 530. The antimatter is accelerated towards the grid 540 and a subset thereof pass through the apertures of the grid 540 to propagate to the antimatter containment vessel 580 for storage therein.

It will be appreciated that, in a known type of Silicon photovoltaic cell, for example a well-known roof-mounted photovoltaic panel, photons are received at a p-n junction of the photocell, resulting in the electrons and antimatter of the photons being preferentially absorbed in p-type and n-type regions of the photocell, respectively, thereby giving rise to an output current from the photocell.

The system 500 is exceptionally efficient for producing antimatter, and the system 500 avoids a need to decelerate high-energy antimatter particles that arise when accelerator-driven antimatter generators are employed to generate antimatter.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

### APPENDIX 1

This appendix discusses previously published theoretical, computational and experimental evidence behind composite photon theory, that is, that the photon is composed of an electron-positron pair. The consequences of this hypothesis are discussed and we build upon the work completed by Gauthier, by exploring the equivalence between mass and charge. A relationship between the Coulomb force and gravitational force is identified and a gravitational constant for strong gravity is examined. Finally, we briefly discuss the expansion of Einstein's field equations to include vector gravity.

Although most of the public may assume that scientists are in agreement about how to interpret the photon, there is not as much consensus as one may think. In particular, there are still debates within the academic community on the fundamental properties of photons.

For instance, a standard claim about photons is that they are massless. In assuming the rest mass of a photon is zero, the implication is that a photon cannot be at rest. Conversely, if the mass of a photon was finite, then in principle, its mass would be measurable (although not necessarily possible with the technology of our time). The consequences of the photon having finite mass include phenomena such as: the speed of light in free space being wavelength dependent, Coulomb's law and Ampère's law having deviations, the existence of longitudinal electromagnetic waves, charged black holes, the addition of a Yukawa component to the potential of magnetic dipole fields, the existence the existence of magnetic monopoles and gravitational deflections (according to Tu et al in “The mass of the photon”, 2004).

Experiments thus far have demonstrated with a high degree of accuracy that electromagnetic radiation, in particular, fluctuating electric and magnetic fields as well as the quanta of light (i.e., the photon), propagates in a vacuum at a constant speed, c, over a wide frequency range.

However, according to the uncertainty principle, if the age of the universe is approximately 1010 years old, then there is an upper bound limit on the possible rest mass of the photon, specifically in the order of 10-66 g. Other more recent studies in the early 2000s suggest that the upper limit of the rest mass could actually be higher, in the order of 10-49 g. A natural question that arises from these considerations is whether or not the equations of motion would remain consistent with a non-zero photon rest mass.

Prior to the nineteenth century, the descriptions of light and radiation, electricity, and magnetism were examined separately. Then, in 1861 and 1862, the behavior of these phenomena were unified by Maxwell's mathematical formulation. His corresponding set of coupled partial differential equations (PDEs) formed the foundation of classical electromagnetism, classical optics and electric circuits and suggest that the speed of all electromagnetic radiation is constant. These PDEs, i.e., Maxwell's equations are defined as the following set (1) of equations:

$$\vec{∇} \cdot \vec{E} = 4 πρ ,$$

$$\vec{∇} \cdot \vec{B} = 0 ,$$

$$\vec{∇} \times \vec{E} = - \frac{1}{c} \frac{\partial \vec{B}}{\partial t} ,$$

$$\vec{∇} \times \vec{B} = \frac{1}{c} \frac{\partial \vec{E}}{\partial t} + \frac{4 π}{c} \vec{J} ,$$

where \vec{E} and \vec{B} denotes the electric and magnetic field vectors, respectively, ρ denoted the charge density, \vec{J} is the current density, and c denotes the speed of light. Maxwell's equations however are not an exact description of electromagnetic phenomena and can be more precisely described using the theory of quantum electrodynamics. Although the typical interpretation of Maxwell's equations is that they result in the photon being massless, the laws of physics themselves do not require this assumption to hold true. With respect to the aforesaid equation set (1), if the photon did have finite mass, it would be incredibly small and Maxwell's equations would have two additional terms as in the following equation set (2):

$$\vec{∇} \cdot \vec{E} = 4 πρ - {( \frac{Mc}{ℏ} )}^{2} V ,$$

$$\vec{∇} \cdot \vec{B} = 0 ,$$

$$\vec{∇} \times \vec{E} = - \frac{1}{c} \frac{\partial \vec{B}}{\partial t} ,$$

$$\vec{∇} \times \vec{B} = \frac{1}{c} \frac{\partial \vec{E}}{\partial t} + \frac{4 π}{c} \vec{J} - {( \frac{Mc}{ℏ} )}^{2} \vec{A}$$

where \vec{A} denotes the magnetic potential vector, V is the electric potential, h denotes Planck's constant (h) divided by 2π, and M denotes the mass of the photon. The above-mentioned equation set (2) of PDEs is referred to as Proca's equations and were first derived in the 1930s. In Proca's equations, since the mass correction terms are in squared, the mass would have a non-zero value and might be detectable.

Then in 1932, Breit and Wheeler published a paper, theoretically examining previous work done by Dirac on antimatter and pair annihilation. The physical process they described is referred to as the Breit-Wheeler effect and states that an electron-positron pair can be created when two photons collide, i.e., pure light can be transformed into matter. Finally in 2021, the Relativistic Heavy Ion Collider (RHIC) in the United States successfully completed an experiment (called the Solenoidal Tracker at RHIC (STAR) detector) validating the Breit-Wheeler effect. The experiment further revealed that a traveling photon in a magnetic field in a vacuum has polarization-dependent deflections.

“The reason that this is so interesting is because a photon has no charge, so it shouldn't, in the classical sense, be affected by a magnetic field. . . . That's why this is a clear proof [evidence] of these very fundamental aspects of quantum mechanics. A photon can constantly fluctuate into this electron-positron pair that does interact with the magnetic field, and that's exactly what we measured”, according to Ferreira in “Government Scientists Are Creating Matter From Pure Light”.

One interpretation of the STAR experimental results is that for the photon, the average charge is zero, but with a distribution that shows positive and negative charge fluctuations about the mean (i.e., there is a statistical nature). Perhaps the same could be said about the mass of the photon.

Another debate in the scientific community regarding the photon that has taken place for almost 100 years (and which this appendix will be focused on) is whether the photon is an elementary particle or composite particle. In various fields of physics, most particles are considered to have an associated antiparticle. The antiparticle can be identified as an object with the same mass as its associated particle, but with opposite physical charges (and other differences in quantum numbers) according to Garcia et al in “Effective photon mass and (dark) photon conversion in the inhomogeneous Universe”, 2020. The majority of physicists however consider the photon to be an exception to this rule. Some argue that since photons do not have an electric charge, a photon would be its own antiparticle. A contradiction to this claim however is the neutrino. In particular, neutrinos are uncharged particles yet they are not their own antiparticles. Antineutrinos have opposite leptonic numbers and weakly interact (i.e., their interaction Lagrangian is non-vanishing) according to Rivas (2021). Thus, perhaps the justifications typically used to argue that the photon is its own antiparticle are not sufficient.

### Background on Composite Photon Theory

It was Louis De Broglie in 1924 who first considered composite photon theory writing in his A Tentative Theory of Light Quanta that “naturally, the light quantum must have an internal binary symmetry”. Although De Broglie's original hypothesis about the photon consisting of two neutrinos was shown experimentally to be incorrect, several other scientists have also argued that composite photon theory can be more descriptive of reality than the elementary theory. For instance, in “Composite photon theory versus elementary photon theory”, Perkins proposes that that composite theory predicts Maxwell's equations, while the elementary photon has been formulated to reflect the equations of motion: In the elementary theory, it is difficult to describe the electromagnetic field with the four-component vector potential. This is because the photon has only two polarization states. This problem does not exist with the composite photon theory.

Other scientists have argued that a consequence of the existence of electromagnetic attraction and repulsion means that both phenomena cannot be mediated by the same particle: attraction corresponds to the interchange of antiphotons whereas repulsion represents the interchange of photons. Further to this claim, Garcia adds that if the main form of electromagnetic radiation of matter is by the emission of photons, then perhaps the main form of electromagnetic radiation of antimatter is by the emission of antiphotons (Garcia et al (2020)).

Scientists are still examining however how antimatter would behave in a gravitational field. In “CPT symmetry and antimatter gravity in general relativity”, Villata examines the possibility of gravitational repulsion between matter and antimatter within the landscape of the general theory of relativity (without any modifications). Since the physical laws are invariant under the combined CPT operations (where Villata defines C (charge conjugation) to be the particle-antiparticle interchange, P (parity) to be the inversion of the spatial coordinates, and T to be the reversal of time), Villata transformed the physical matter system into an equivalent antimatter system in the equations from both electrodynamics and gravitation 1. In the former case, by looking at the Lorentz force law, which describes the dynamics of a charged particle in an external electromagnetic field, Villata arrived at the well-known change of sign of the electric charge. In the latter, he finds that the gravitational interaction between matter and antimatter is a mutual repulsion, i.e., antigravity appears as a prediction of general relativity when CPT is applied. If this result is true, it supports cosmological models attempting to explain the accelerated expansion of the universe in terms of a matter-antimatter repulsive interaction.

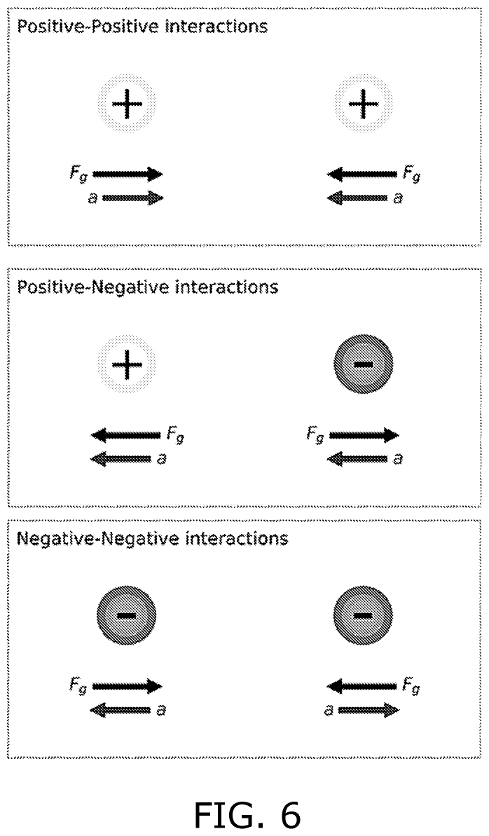

Using Bondi's work from 1957 in which he examined the negative mass hypothesis within the framework of general relativity, one could interpret Villata's findings to mean that all kinds of mass (inertial, passive gravitational and active gravitational mass) are negative. For the negative mass, the acceleration of the body would be in the opposite direction to the gravitational force. A summary of such interactions are illustrated in FIG. 6. In particular, FIG. 6 illustrates a comparison of positive versus negative mass for composite particle interactions.

Gauthier is another who has done extensive work on composite photon theory. In “Quantum-entangled superluminal double-helix photon produces a relativistic superluminal quantum-vortex zitterbewegung electron and positron.”, 2019, Gauthier elaborates on the composite model to be a double-helix model, which consists of an electron-positron pair spinning around each other in a helical motion with two quantum-entangled spin-½half-photons. He claims that the parameters of energy, frequency, wavelength and helical radius of each spin-½ half-photon composing the double-helix photon would remain the same in the 2 transformation of the half-photons into the relativistic electron and positron quantum vortex models. In 1958, De Broglie considers a similar idea stating in “The Revolution in Physics: A Nonmathematical Survey of Quanta” that

The photon being thus made up of two corpuscles, each with a spin for a total of should obey the Bose-Einstein statistics, as the exactness of Planck's law of black body radiation demands. Finally, this model of the photon permits us to define an electromagnetic field connected with the probability of annihilation of the photon, a field which obeys the Maxwell equations and possesses all the characters of the electromagnetic light wave . . . such a couple of complementary corpuscles can annihilate themselves on contact with matter by giving up all their energy, and this accounts completely for the characteristics of the photoelectric effect.

Caroppo and Bolland also published similar work in 2005 and 2018, respectively.

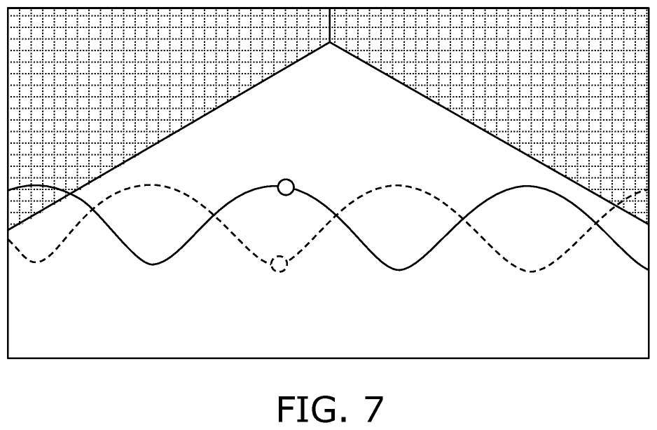

Gauthier's double-helix model of the photon (as illustrated in FIG. 7) provides a preferable description and imagery when considering composite photon theory. “The conventional idea of a composite particle” may provide an unintended picture, which is why it is preferred to use the terminology couplet photon theory. In particular, the physics community defines a composite particle as a subatomic particle being composed of two or more elementary particles, i.e., a subatomic particle that consists of more than one quark. In quantum mechanics vocabulary, composite particles are considered as bound states with a binding energy which is larger than twice the mass of the lighter constituent allowing for spontaneous pair creation. As the binding energy increases, it becomes more difficult to separate the components of a composite particle. From a theoretical framework, it is important to consider the binding energy of the photon relative to its mass and size. Some limited discussions can be found in the literature (e.g., “Photon's Spin, Diffraction, and Radius, the One-photon Hypothesis, and Stopped Photon” by H. V. Dannon, “A new linear theory of light and matter” by J. G. Williamson, “Massless states and negative mass states of the coupled electron-positron system with completely symmetric representation of the particles” by A. I. Agafonov), but the topic requires additional careful study. It is speculated however that in couplet photon theory, the positive binding electric energy would be offset by the negative gravitational binding energy (since the gravitational force is repulsive). If this is true, then the implication would be that the net binding energy would be zero.

Although it is intriguing to consider the composite photon model, as scientists, we need to test against any claims to verify whether the photon is an electron-positron pair. If it is the case that photons and antiphotons can have opposite mechanical properties, then in theory, a sort of optical device may be used to determine whether their behaviour would differ. Garcia suggests using an experimental setup involving conducting media and proposed a type of telescope that could be one such device. In particular, Garcia explains that photons, or quantum of light, carry energy, linear momentum and spin. Hence, a beam of photons can be thought of as an electromagnetic wave carrying energy, linear momentum and angular momentum. Garcia further suggests that if we consider a photon moving in a transparent homogeneous and non-conducting medium, a beam of monochromatic protons can be interpreted as an electromagnetic polarized plane wave. In this situation, from an electromagnetic perspective, the photon and antiphoton would behave the same way in such a medium (i.e., a refracting telescope would behave in the same way). However, if the photon was moving in a conducting medium, such as a mirror, then a beam of monochromatic photons can be considered as particles and would experience the opposite force when interacting with mirrors. Although this experiment has not been completed, some science research groups have conducted experiments in an attempt to verify some of the proposed ideas summarized above.

### Experimental Evidence for Composite Photon Theory

One set of experiments testing a proposed photon model were conducted by Bolland in 2000, though he formally published his results in 2011 in “Photon findings”. Bolland's experiments used microwave equipment and a Gunn diode oscillator to examine the electric field strength of microwaves transmitted along a bench. He placed a metallic plate in the center of the bench such that the plate's edge intercepted with half the beam. In the initial experimental setup, a parabolic reflector was used to focus the linear polarization radar beam toward a horn antenna and diode, which was coupled to a field strength meter. In the second experiment, the horn antenna and parabolic reflector were replaced by two helical antennas. Bolland expected that if the photon were pure energy, the resulting electric field strength to describe it would be a sine wave. However, Bolland found that for his first experiment, the plotted measured strength was a double-cycloid. He claimed that this outcome was consistent with the hypothesis that the photon consisted of two particles and further hypothesized that the two particles could be an electron-positron pair. In the second experiment, the plotted helical field strength trajectories obtained found circular polarization further suggesting that the photon consists of two particles.

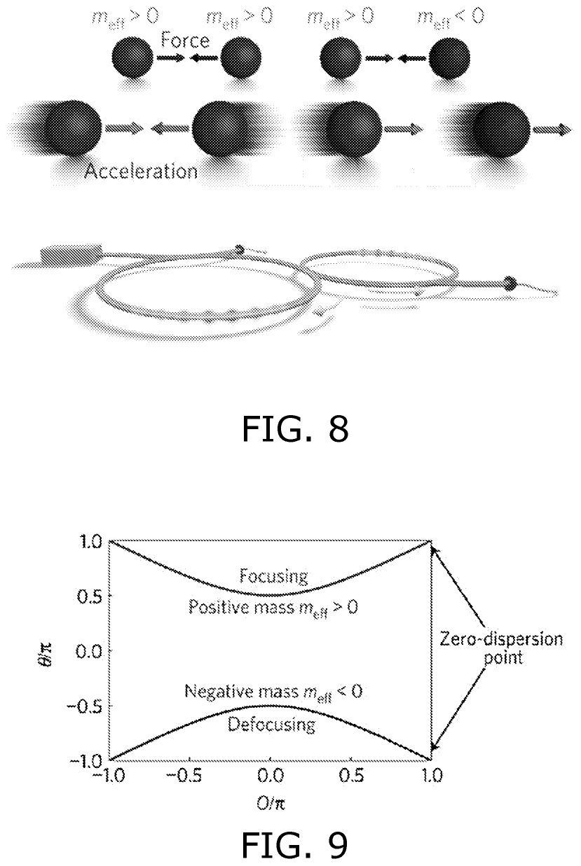

In 2013, Wimmer et al. wanted to perform an experiment to test the hypothesis that the photon's composition consists of two symmetrical half-photons: one of positive mass and one of negative mass. In classical physics, Newton's third law of motion is considered with mass as a positive quantity. This property implies that two bodies would either accelerated away or toward each other. Theoretically speaking, if one of the bodies instead had negative mass, then the two bodies would accelerate in the same direction and one could create a diametric drive propulsion system. A setup that could be used to study action-reaction symmetry breaking effects of diametric drive acceleration could be achieved using periodic structures (i.e., waves) propagating in a nonlinear time-domain optical mesh lattice. In “Optical diametric drive acceleration through action reaction symmetry breaking”, the authors present in experimental findings where they did just that. In particular, the authors produce two optical Gaussian wave packets with opposite masses and a slight frequency difference so their interaction would be incoherent and have pure cross-phase modulation. The self-trapped wave packets nonlinearly interacted with the defocused beam. The authors reported that they found symmetrical halves of negative and positive mass on a dispersion diagram for light pulses interacting, which are illustrated in FIGS. 8 and 9. The laser pulses also appeared to display runaway self-acceleration, as outlined in FIG. 6. A top portion of FIG. 8 shows mass interactions whereas a bottom portion of FIG. 8 shows a set-up of two time-multiplexed fiber loops connected through a 50/50 coupler. Sequences of light pulses circulating in both loops obey the same dynamics as in a spatial mesh lattice. FIG. 9 represents a Dispersion diagram associated with two oppositely curved bands. The Kerr nonlinearity tends to focus excitations in the upper band whereas the corresponding effects in the lower band are of the defocusing type. Q, wave number; θ, propagation constant. The setup of FIG. 8 provides a relatively inexpensive and simple implementation of an embodiment of the present invention.

Similar experiments were conducted and published by Pei et al. in 2019 (in “Coherent propulsion with negative-mass fields in a photonic lattice”) and in 2020 (in “Spontaneous diametric-drive acceleration initiated by a single beam in a photonic lattice”). In particular, the publications describe an optical diametric drive that is spontaneously self-accelerating. The authors speculated that the self-accelerating behaviour “driven by a nonlinear coherent interaction of its two components [which] are experiencing diffractions of opposite signs in [the] photonic lattice (which is analogous to the interaction of two objects with opposite mass signs)” is the expected interaction of negative mass with positive mass particles. The authors further found that a single Gaussian-like beam can ‘self-bend’ during nonlinear propagation in a uniform photonic lattice.

As discussed in Wimmer et al. in 2013 (in “Optical diametric drive acceleration through action-reaction symmetry breaking”), in the absence of an electrical field, the defocusing behaviour of positron beams is further evidence of the negative mass to negative mass interaction. This is because negative mass to negative mass repels and causes the positrons to move apart or ‘defocus’. Some scientists have explored the idea of conducting an experiment to quantify the mass of a positron. However, standard experiments to determine the mass of particles (such as using a cathode ray tube as done by JJ Thompson for the discovery of the electron in 1897, or using a bubble-chamber experiment which was invented in 1952 by Glaser do so by measuring the angle of electromagnetic deflection. This yields the charge of the particle and the magnitude of its mass, but not its sign. The problem with such setups is there is no gravitational potential gradient in spectroscopy experiments to determine the mass/charge ratio of antimatter particles, i.e., such experimental setups were not designed to determine whether the mass would be positive versus negative.

Despite this, from the discussed experimental findings, it does not seem reasonable to dismiss the composite theory for the photon without additional investigation. From a theoretical perspective, the hypothesis that the photon is an electron-positron pair does not contradict important properties of the photon such as having zero rest mass (as the electron has positive mass and the positron has negative mass) or that it travels at the speed of light (since runaway, or self-accelerating, motion between positive and negative mass could provide an explanation). The interaction itself between positive and negative masses also does not pose a problem. This is because positive masses have an attractive effect on each other (which is why large scale structures such as stars and galaxies can form), whereas negative masses have repulsive gravitational effect with each other. Additionally, as mentioned by Choi and Rudra (in “Pair creation model of the universe from positive and negative energy”), if negative mass (energy) exists, it is still possible to explain the dark matter and the dark energy at the same time.

### Evidence for Antimatter Having Negative Mass

Composite photons consisting of particle-antiparticle pairs having positive and negative mass provide a physical interpretation at the level of particle physics for the pair creation model of the universe developed by Choi and Rudra. This idea provides a consistent and lucid explanation of how the universe developed from net zero energy and evolved into the distribution of energy density we observe today. In particular, Choi and Rudra present computational results from their ‘pair creation of positive energy and negative’ model to investigate whether their simulations correspond to the energy ratio of the universe's components (i.e., matter, dark matter and dark energy). They compared their simulation results to observational data collected from NASA's Wilkinson microwave anisotropy probe (WMAP) and Planck probe. They obtained reasonable results (summarized in Table 1) demonstrating that the negative mass (energy) satisfies energy conservation. Furthermore, their models suggests that as the universe expands, the gravitational effects of matter compared to dark matter effects differ. Comparatively, the standard lambda cold dark matter (ΛCDM) model assumes that the ratio of matter and dark matter will be constant.

TABLE 1
Energy distribution in the universe from NASA probe observational
data and simulation results from the work of Choi and Rudra.

| | WMAP | Simulation | Plank |
|---|---|---|---|
| Matter | 4.6 | 4.5 | 4.9 |
| Dark Matter | 23.3 | 25.1 | 26.8 |
| Dark Energy | 72.1 | 70.3 | 68.3 |

Composite photons consisting of particle-antiparticle pairs having positive and negative mass further provides a physical interpretation at the level of particle physics for the gravitational dipoles proposed by Hadjukovic in “Virtual gravitational dipoles: The key for the understanding of the Universe?”. In this paper, Hadjukovic suggests that a solution to the cosmological constant problem is if the particle-antiparticle pairs are gravitational dipoles, then without external fields, the gravitational charge density of the quantum vacuum is zero and hence, the cosmological constant is zero. A small non-zero cosmological constant would come about as a consequence of immersed matter.

Further support is given to negative mass cosmologies from the work developed and presented by Farnes in “A unifying theory of dark energy and dark matter: Negative masses and matter creation within a modified ΛCDM framework”, where his results correspond well to observational evidence of the interactions and behaviour of dark matter and dark energy.

In this paper, Farnes proposed a model and then tested it computationally using software he developed to perform three-dimensional gravitational N-body simulations. The series of N-body simulations examined particles velocities and positions at every time-step until obtaining the final particle distribution. Farnes summarizes his findings saying:

The proposed cosmological model is therefore able to predict the observed distribution of dark matter in galaxies from first principles. The model makes several testable predictions and seems to have the potential to be consistent with observational evidence from distant supernovae, the cosmic microwave background, and galaxy clusters. These findings may imply that negative masses are a real and physical aspect of our Universe, or alternatively may imply the existence of a superseding theory that in some limit can be modelled by effective negative masses.

Choi similarly speculated that negative mass has not been observed because even though it is gravitationally bounded to massive positive masses (e.g., galaxies), it came into existence at the beginning of universe and hence, could still exist in a vacuum state outside a galaxy structure. Choi further suggests that galaxy structures have survived as a result of pair-annihilation of positive mass and negative mass pair which also results in the vacuum energy being zero. The composite photon development that will be given below thus benefits from the same observational evidence, which must be contrasted with the absolute failure of experiments to detect dark matter particles or dark energy in the laboratory.

### Equality of Forces Acting on the Electron-Positron Pair

Considering the claim that the photon is an electron-positron pair and that a repulsive gravitational force acts between matter and antimatter, we will now calculate the strength of the gravitational force and examine the hypothesis that it is equivalent to the Coulomb force (i.e., electrostatic force).

To begin, we know that the gravitational force has the same form as Coulomb's law for the forces between electric charges, i.e., it is an inverse square force law which depends upon the product of the two interacting sources. In particular, if we consider two masses m₁ and m₂ separated by a distance r, then the gravitational force F_{Gravitational} between these two masses is given by

$${}^{F} Gravitational = \frac{{Gm}_{1} {m}_{2}}{{r}^{2}}$$

where G is the universal gravitation constant. If we consider two points with charges q₁ and q₂ measured in Coulombs where r is the radius of separation from the center of one charge to the center of the other charge, then Coulomb's law states that the electrostatic force F_{Coulomb} is defined as

$${}^{F} Coulomb = \frac{k {q}_{1 q} {q}_{2}}{{r}^{2}} .$$

where k is Coulomb's constant and is equal to

$$\frac{1}{4 {πε}_{0}}$$

where ε₀ is the electric constant, i.e.,

$${}^{F} Coulomb = \frac{{q}_{1 q} {q}_{2}}{4 {πε}_{0} {r}^{2}} .$$

Note that the attractive Coulomb force acts between a negatively charged electron and positively charged positron.

As presented by Gauthier (2019), let's now consider two half-photons with mass mₑ moving on 45-degree helical trajectories separated by a distance

$$D = \frac{λ}{π} ,$$

where λ denotes the wavelength of the photon. In the double-helix charged dipole model, the two half-photons carry a charge q1=Q and q2=−Q that allows for their double-helical trajectories.

$$\begin{matrix}\begin{matrix}{}^{F} Coulomb = \frac{{q}_{1 q} {q}_{2}}{4 {πε}_{0}} \frac{1}{{r}^{2}} \\ = \frac{- {Q}^{2}}{4 {πε}_{0}} \frac{1}{{D}^{2}}\end{matrix}\end{matrix} \qquad ( 3 )$$

We will use Gauthier's expression for the magnitude of the charge on each helically-moving half-photon on the charge dipole, which is

$$Q = \pm e \sqrt{\frac{2}{α}} \approx 16.6 e$$

where e is the electron's charge magnitude and α is the fine structure constant (which quantifies the strength of the electromagnetic interaction between the electron-positron pair).

Note that we can relate the two quantities by the formula

$${e}^{2 =} 4 πε 0 ℏc α \approx \frac{1}{137} .$$

The weak equivalence principle tells us that the inertial mass is equivalent to the gravitational mass. Moreover, from the CPT theorem, we can say that the inertial mass of a particle is equal to that of the antiparticle. For this new description of mass, we view the electron-position as gravitational charge, which has a magnitude and a sign. Like electrical charges, gravitational charges will move along a potential gradient. This potential gradient will, however, be gravitational (whereas current experiments to measure mass have no gravitational gradient, so they cannot tell us the sign the sign of the mass). Hence m₁=mₑ and m₂=−mₑ and we can write the gravitational force as

$${}^{F} Gravitational = \frac{G {m}_{1} {m}_{2}}{{r}^{2}} \qquad ( 4 )$$

$$= \frac{- G {m}_{{e}^{2}}}{{D}^{2}}$$

Assuming that the photon is a stable particle and has wavelengths spanning the electromagnetic spectrum and ranging from 100,000 km to one picometre, the two forces (^{F}Coulomb and ^{F}Gravitational) would be equal and offsetting, i.e.,

$${}^{F} Coulomb = {}^{F} Gravitational \qquad ( 5 )$$

Using equations (3) and (4), equation (5) can be written as

$${}^{F} Coulomb = {}^{F} Gravitational$$

$$\frac{Q 2}{4 π {ε}_{0} {D}^{2}} = \frac{{G}_{s} {m}_{e} {m}_{e}}{{D}^{2}}$$

$${G}_{s} = \frac{Q 2}{4 {πε}_{0} {{m}_{e}}^{2}}$$

where G_{S} denotes the strong gravitational force. Since the charge of the electron squared is e2=4πε0ℏcα, G_{S} can be expressed in the following equation set (6):

$${G}_{s} = \frac{{( \pm e \sqrt{\frac{2}{α}} )}^{2}}{4 {πε}_{0} {{m}_{e}}^{2}}$$

$$= \frac{( 4 {πε}_{0} ℏ c α ) \frac{2}{α}}{4 {πε}_{0} {{m}_{e}}^{2}}$$

$$= \frac{2 ℏc}{{{m}_{e}}^{2}}$$

Equation set (6) gives the value of the strong gravitational constant, G_{S}, such that the gravitational force becomes equal to the Coulomb force. Note that the value of G_{S} is independent of the wavelength of the photon and acts on all photons, regardless of their energy. Since the electromagnetic spectrum covers wavelengths ranging from 100,000 km to one picometre, the force is not microscopic in range but rather operates across a wide range of distances as Newtonian gravity does.

To show the strength of the repulsive gravitational force acting between matter and antimatter is enormously strong compared to Newtonian gravity, notice the following: if Mp is the Planck mass, then for Newton's gravitational constant the gravitational force is expressed as equation (7):

$$G = \frac{ℏc}{{{M}_{p}}^{2}}$$

which indicates the existence of a strong version of the gravitational force operating inside the composite photon consisting of an electron-positron pair. By considering the ratio of the two, we find equation (8):

$$\frac{Gs}{G} = \frac{2 {Mp}^{2}}{{{m}_{e}}^{2}}$$

i.e., G_{S} is 45 orders of magnitude stronger than G. This provides a unification between the electromagnetic force and the gravitational force, at least in the case of the electron-positron pair. Since photons can take on energies across the electromagnetic spectrum, it does not make sense to think of unification taking place at a particular energy level. Unification between the Coulomb force and the gravitational force takes place through a variation in the value of the gravitational constant, which is much higher for the strong gravitational force between the electron and the positron.

However, an important question to ask is whether this is truly a unification or simply an equivalence. By writing equation (5), as follows

$${}^{F} Coulomb = {}^{F} Gravitational$$

$$\frac{{Q}^{2}}{4 {πε}_{0} {D}^{2}} = \frac{{G}_{s} {{m}_{e}}^{2}}{{D}^{2}}$$

$$\frac{2 {e}^{2}}{4 {πε}_{0} α {D}^{2}} = \frac{{G}_{s} {{m}_{e}}^{2}}{{D}^{2}}$$

$$\frac{2 {e}^{2}}{{G}_{s} {D}^{2}} = \frac{4 {πε}_{0} α {{m}_{e}}^{2}}{{D}^{2}}$$

and in this representation, we obtain that an electromagnetic force with a gravitational constant is equivalent to strong gravity with an electromagnetic constant. The two forces are different aspects of the same force where one is attractive and the other repulsive. This is providing a rationale for our claim of a unification between gravity and electromagnetism showing the origin of the two forces inside the composite photon.

This analysis provides a framework for the unification of the four fundamental forces of nature (recall that the weak force, electromagnetic force and strong force have already been shown to unify—see more below). Furthermore, our findings provide a potential resolution to the hierarchy problem (i.e., the large discrepancy between aspects of the weak force and gravity) regarding why Newtonian gravity is so much weaker than the other forces.

The composite photon model developed by Gauthier and further augmented here provide some deep insights into the process of the transformation of light into matter and antimatter as well as the annihilation process of matter and antimatter into photons.

### Positronium Approximation of Strong Gravity

Another possible method to estimate the strength of the repulsive gravitational force is by considering the bound quantum state known as positronium, which is an atom that is composed of an electron and positron (i.e., it's antiparticle). If annihilation is actually the acceleration of an electron-positron pair from s-state positronium to gamma rays, then we can calculate the rate of acceleration and back out the strength of the force and the constant of strong Gravity. The strength of the force acting between matter and antimatter can be implied from the rate of acceleration of the positronium.

Recall that an s-state has zero angular momentum, i.e., overall spin quantum number is s=0. The levels with spin s=0 are called para-positronium levels. If we consider the lifetime of para-positronium in a vacuum to be t0, it is approximated by

$${t}_{0} = \frac{2 ℏ}{m {c}^{2} {α}^{5}} \qquad ( 9 )$$

Using the composite photon model, we can say that the electron-positron pair accelerates from rest to the speed of light, c, in time to. Since acceleration, denoted by a, can be expressed as the change in velocity over the change in time, we can obtain the following expression:

$$a = \frac{Δ v}{Δ t} \qquad ( 10 )$$

$$= \frac{c}{{t}_{0}}$$

$$= \frac{c {m}_{e} {c}^{2} {α}^{5}}{2 ℏ}$$

Since we know that F_{Gravitational}=−mₑa, we find that

$${}^{F} Gravitational = - {m}_{e} ( \frac{{m}_{e} {c}^{3} {α}^{5}}{2 ℏ} ) \qquad ( 11 )$$

$$= - \frac{{{m}_{e}}^{2} {c}^{3} {α}^{5}}{2 ℏ}$$

Furthermore, we can express

$${}^{F} Gravitational = - \frac{{G}_{S} {{m}_{e}}^{2}}{{D}^{2}}$$

where D would correspond to the orbital radius of the system/atom. This then yields

$$\frac{{G}_{S} {{m}_{e}}^{2}}{{D}^{2}} = \frac{{{m}_{e}}^{2} {c}^{3} {α}^{S}}{2 ℏ} \qquad ( 12 )$$

$${G}_{S} \frac{{D}^{2} {c}^{3} {α}^{5}}{2 ℏ}$$

To approximate the value of D, the average orbital diameter between positronium and soft gamma rays (which positronium transfers into) was taken. The justification behind this is during acceleration, the distance between the electron and positron contracts from the diameter of positronium (in the rest state) to that of soft gamma rays. We know that the wavelengths of soft gamma rays are roughly 100 picometers (from “What are gamma rays” by K. Lucas), so the diameter would correspond to

$$\frac{100 pm}{π} .$$

Next, the orbital radius of positronium in its rest state is twice that of the Bohr radius (i.e., the diameter would be approximately 4*5.29177⁻¹¹ m). Therefore, taking the average of these diameters would give that D≈122 picometers.

By again considering the ratio between this approximate value of Gₛ and G, Gₛ would be 39 orders of magnitude stronger than G. Although this ratio of G_{S} and G is different than the previous calculation of the strong gravitational constant (i.e., (8)), the current calculation involves estimates for the radius of positronium at rest as well as for the wavelength of soft gamma rays.

Since equation (12) is expressed with a factor of D², the error in D will magnify the corresponding error of G_{S}. Nonetheless, from equations (6) and (12), it appears that the strong gravitational constant would be 10³⁹ to 10⁴⁵ orders of magnitude more powerful than Newtonian gravity. More importantly, by considering the hypothesis that annihilation is actually acceleration of the electron-positron pair, a reasonable approximation for the value of G_{S} was obtained.

### Gravity in the Early Universe

In contemplating whether the composite photon theory is reasonable or not, it would be beneficial to reflect on the origins of gravity. Prior to the first 10⁻⁴³ second after the big bang, which is referred to as Planck time or the Planck era, the scientific community believes there was unification of all the fundamental forces. In other words, the forces resembled each other and were of practically identical strength (as the forces of nature are symmetric at high energies and temperatures). However, after the unification point or Planck era, there was spontaneous symmetry breaking. This separated the ‘original force’ into four distinct fundamental forces which function in our current, low temperature universe. The four fundamental forces are the strong force, the weak force, the electromagnetic force and the gravitational force. All these forces function at different strengths and in different ranges. In particular:
1. Strong force: range of 10⁻¹⁵ m with strength 1.
2. Weak force: range of 10⁻¹⁸ m with strength 10⁻⁶.
3. Electromagnetic force: infinite range with strength 1/137
4. Gravitational force: infinite range with strength 6×10⁻³⁹.

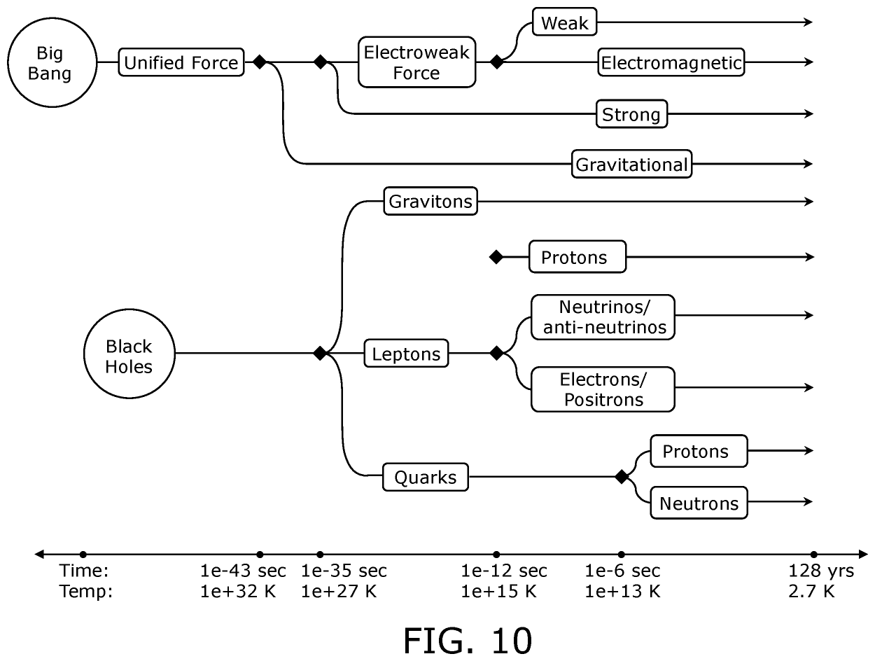

FIG. 10 is an illustration of this symmetry breaking as a function of time after the big bang. The proposed temperatures corresponding to each of the symmetry breaks are shown.

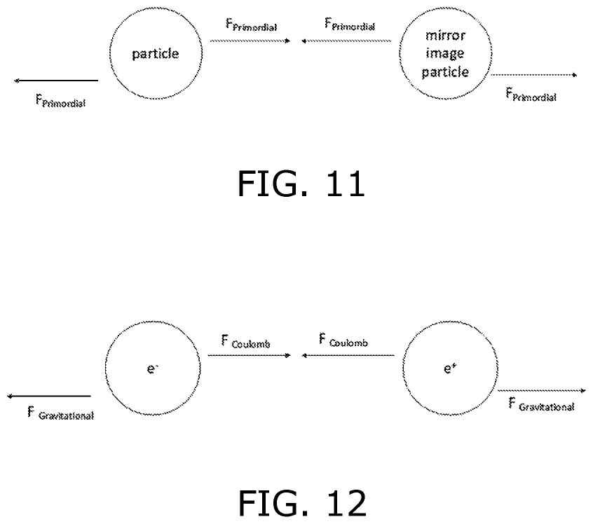

The FIG. 11 presents a picture of the primordial force in the early universe, where one force is attractive and one is repulsive. This figure demonstrates a symmetrical beginning for the universe with net-zero energy. In comparing this idea to the gravitational and Coulomb force, these forces appear to be different aspects of the same primordial force as shown in FIG. 12. This may provide an understanding of how the Coulomb force and gravitational force are different aspects of the same primordial force.

Examining the strong gravitational force may tell us something about the origin of gravity as it can be expressed by the following equation (13):

$${F}_{Gravitational} = \frac{{G}_{S} {m}_{e}^{2}}{{D}^{2}} = \frac{2 hc}{2 π {D}^{2}}$$

for the electron-positron pair (i.e., the elementary charged particles). This relationship follows an inverse square law that depends on distance, but is independent of the gravitational constant. If lₚ² is the Planck length constant, we can substitute this minimum length into equation (13). Then F_{Gravitational} tends to a maximum value as shown in the below equation (14):

$${F}_{Max} = \frac{2 hc}{2 π {l}_{p}^{2}}$$

as the distance between the electron and positron tends to the Planck length and is repulsive. Moreover, since

$${l}_{p}^{2} = \frac{ℏ G}{{c}^{3}} ,$$

we can see in the below equation (15):

$${F}_{Max} = \frac{2 hc}{2 π {l}_{p}^{2}} = \frac{2 hc}{ℏ G} {c}^{4} = \frac{2 {c}^{4}}{G}$$

Notice equation (15) corresponds to two times the Planck force, which is associated with each cycle of a photon. Hence, at the minimum quantum distance, the strength of this force corresponds to the strongest possible force in nature, which is expected to be present at the origin of the universe. Thus, this analysis speculates that the composite photon may represent the origin of the universe.

We now consider if it is possible to say something more general about the relationship between mass and charge under repulsive gravity with the strong gravitational constant that we have calculated. Moving beyond the electron-positron pair to a more general case, we consider a charge, denoted by Q. We can solve for the mass, denoted by m, which would have that the Coulomb force and the gravitational force are the same:

$${F}_{Coulomb} = {F}_{Gravitational}$$

$$\begin{matrix}\frac{{Q}^{2}}{4 {πε}_{0} {D}^{2}} = \frac{{G}_{S} {m}_{e}^{2}}{{D}^{2}} \\ \frac{{Q}^{2}}{4 {πε}_{0} {D}^{2}} = \frac{2 ℏ {cm}_{e}^{2}}{{m}_{e}^{2} {D}^{2}} \\ \frac{2 {e}^{2}}{4 {πε}_{0} α} = 2 ℏ c \\ \frac{{e}^{2}}{4 {πε}_{0} α} = ℏ c\end{matrix}$$

Since the Planck charge, denoted qₚ can be expressed as qₚ=\sqrt{4πε₀ℏc}, we can write

$${e}^{2} = \frac{2 {e}^{2}}{α} .$$

We also know from Gauthier that

$${Q}^{2} = \frac{2 {e}^{2}}{α} ,$$

hence our above expression becomes

$$\begin{matrix}\frac{{e}^{2}}{4 {πε}_{0} α} = ℏ c \\ \frac{{q}_{p}^{2}}{4 {πε}_{0}} = ℏ c \\ \frac{{q}_{p}^{2} ℏ c α}{{e}^{2}} = ℏ c \\ \frac{2 {q}_{p}^{2} ℏ c}{{Q}^{2}} = ℏ c \\ \frac{2 {q}_{p}^{2} ℏ c}{{Q}^{2}} = 1\end{matrix}$$

Thus, we have found that the Planck charge occupies the same position for charge that the mass of the electron occupies for mass. If the electron mass is fundamental to the origin of the universe from the composite photon, then so is the Planck charge.

### Expansion of Einstein Field Equations to Include Vector Gravity

As discussed, there is some rather compelling evidence already published in the literature to suggest that a symmetrical beginning for the universe with net-zero energy and particles that are mirror images of each other could result in positive and negative electromagnetic charges as well as positive and negative gravitational charges (where there exists positive mass for matter and negative mass for antimatter). Furthermore, according to Nieto and Goldman, current experimental evidence does not exclude the possibility of vector gravity for antimatter:

From the particle-physics point of view, general relativity is a theory of gravity where the force is mediated by a tensor (spin-two) particle with the charge being mass energy. Therefore, the force is always attractive. On the other hand, classical and quantum electromagnetism both have two charges, positive and negative. The forces are mediated by a vector (spin-one) field which produces an attractive force between opposite charges and a repulsive force between like charges.

At present, it is useful to ask whether a mathematical framework is compatible with a theory that a repulsive force between matter and anti-matter exists.

From the general theory of relativity, the geometric relationship of spacetime to the distribution of matter within it are described using Einstein's field equations, which are a set of nonlinear PDEs whose solutions are the components of the metric tensor. However, Einstein's theory is not perfect (e.g., there are issues in describing spin-orbit interaction) and only describes the positive-positive tensor equations. The Lorentz invariant theory of gravity (LITG) is an alternative in the weak gravitational field approximation. LITG more resembles Maxwell's electromagnetic theory in the sense that the PDEs describe the properties of two components of the gravitational field and relates them to their sources, mass density and mass current density. In particular, unlike general relativity, in LITG, gravity is not considered a consequence of spacetime curvature. Instead, it is considered a force and results in the Lorentz covariance of gravitational field in the weak field limit as well as the need for torsion of gravitational field (i.e., the force field acting on the masses and bodies in transnational or rotational motion). The gravitational field is therefore described via two potentials and two strengths.

The question now is: can the positive-negative interaction between the positive gravitational charge and negative gravitational charge be described by another set of gravitational equations, optimally in the form of Maxwell's equations? If so, Einstein's field equations would need to be expanded to include strong gravity, which recall is repulsive between positive mass and negative mass. Fortunately, the relationship to Coulomb's Law discussed above provides a basis for such an expansion. Similar to LITG, we can say that an equivalence to Maxwell's equations can be developed since we may now view gravity as gravitational charge having positive and negative charges in the same manner as electromagnetism.

Recall that Maxwell's equations for electromagnetism may be derived from Coulomb's Law plus the Lorentz invariance transformations of special relativity. In a parallel manner, an extended version of Einstein's field equations can be obtained from Newton's law of gravitation plus special relativity. This extension would include interactions between the positive and negative gravitational charges and reflect the strong gravitational constant calculated in this paper for the interaction between positive and negative mass. As discussed thoroughly in Fedosin's paper “Electromagnetic and gravitational pictures of the world.”, the equations of motion from LITG are sufficient for our desired description. The vector equations set (16) have the following form:

$$\begin{matrix}\vec{∇} . \vec{Γ} = - 4 π {G}_{S} ρ \\ \vec{∇} . \vec{Ω} = 0 \\ \vec{∇} \times \vec{Γ} = - \frac{\partial \vec{Ω}}{\partial t} \\ \vec{∇} \times \vec{Ω} = \frac{1}{{{C}_{g}}^{2}} ( - 4 π {G}_{S} \vec{J} + \frac{\partial \vec{Γ}}{\partial t} ) \\ \vec{∇} \times \vec{Ω} = \frac{1}{{{C}_{g}}^{2}} ( - 4 π {G}_{S} ρ \vec{{v}_{p}} + \frac{\partial \vec{Γ}}{\partial t} )\end{matrix}$$

Where \vec{Γ} denotes the gravitational field strength vector, \vec{Ω} denotes the gravitational torsion field vector, \vec{J} denotes the mass current density vector, r denotes the mass density, \vec{vₚ} denotes the mass flow velocity, and C_{g} is the speed of propagation of gravitational effects. In LITG, C_{g} is not necessarily equal to the speed of light, c.

The equations set (16) is a description of gravito-electromagnetism and are the gravitational analogs to Maxwell's equations for electromagnetism. Unlike general relativity, which is a theory of the metric field (rather than a gravitational field), in LITG, the gravitational field also determines the metrics. For a more extensive overview on the mathematical details behind this formalism, Fedosin's paper can be referred to.

In “Quantum Vacuum Gravitation Matter-Antimatter Antigravity” by Constantin Meis, there is shown that Newton's gravitational law is equivalent to Coulomb's electrostatic law. Furthermore, Meis draws that gravitational constant G is the same for matter and antimatter but gravitational forces could be repulsive between particles and antiparticles because their masses bear naturally opposite signs. In this paper, it is discussed that gravitational forces are attractive between bodies of ordinary matter as well as between bodies of antimatter, but they should be repulsive between matter and antimatter since their masses are expressed through the electron and positron charge respectively and consequently bear opposite signs. It is mathematically shown that Newton's gravitational potential for elementary masses is equivalent to Coulomb's electrostatic potential for elementary charges. It is stated that a particle and an antiparticle of opposite charge are attracted by Coulomb forces overcoming naturally the weak gravitational repulsion and annihilate mutually giving generally birth to photons. Conversely, matter and antimatter neutral structures must be repelled due to repulsive gravitational forces. This is in agreement with previous studies that have shown that CPT symmetry (Charge conjugation, Parity and Time reversal) and General Relativity cannot be compatible unless matter and antimatter are mutually repelled.

### APPENDIX 2

The question of whether the photon is an elementary particle or composite has been a matter of debate for almost 100 years since Louis De Broglie published his paper, “A Tentative Theory of Light Quanta” in 1924. De Broglie wrote “Naturally, the light quantum must have an internal binary symmetry”. The composite theory is more descriptive of reality than the elementary theory.

Bolland (2000) experimentally showed that the photon is a composite particle that includes two particles. In the experiments, a microwave generator was set up to emit a beam of microwaves, which are photons, along a bench. As the beam travelled horizontally along the bench, the strength of the electromagnetic field was sampled (using a field-strength detector) at various points along the bench. A parabolic antenna was used to focus the beam. A horizontal movement system with a metallic plate was installed and used. The experimental data obtained is given below in Table 2

TABLE 2

| Translational | Field | Translational | Field |
|---|---|---|---|
| Displacement | strength | Displacement | strength |
| (in cm) | (in μW) | (in cm) | (in μW) |
| 10 | 46 | 11.3 | 46 |
| 10.1 | 46 | 11.4 | 47 |
| 10.2 | 43 | 11.5 | 46 |
| 10.3 | 38 | 11.6 | 43 |
| 10.4 | 32 | 11.7 | 39 |
| 10.5 | 19 | 11.8 | 35 |
| 10.6 | 9 | 11.9 | 28 |
| 10.7 | 8 | 12 | 16 |
| 10.8 | 16 | 12.1 | 7 |
| 10.9 | 26 | 12.2 | 8 |
| 11 | 35 | 12.3 | 18 |
| 11.1 | 39 | 12.4 | 30 |
| 11.2 | 42 | 12.5 | 36 |

When the above experimental data was plotted graphically, it was observed that trajectories of photons followed double cycloidal paths. If the photons were single elementary particles and just represented pure energy, their trajectories should have described a sine wave. Since the trajectories of photons showed interlaced waves which formed a double cycloid, the experiment concluded that the photon consists of two particles. The double cycloid paths were found in linear polarization, whereas spiral paths were found in circular polarization. In the circular polarization experiment, the same equipment described above was employed, but two helical antennas are employed instead of the parabolic antenna.

Gauthier (2019) has done extensive work in this area and elaborates a composite model consisting of an electron-positron pair spinning around each other in helical motion. According to a model developed by Gauthier, when a positron and an electron meet, they annihilate and cancel each other, but don't actually disappear. Instead, these two particles self-accelerate, move forward at the speed of light and spin in a helix by spinning around each other. They act as a single entity, until such time as the environment is changed and they split again. He finds that the parameters of energy, frequency, wavelength and helical radius of each spin-½, half photon composing the double-helix photon remain the same in the transformation of the half photons into the relativistic electron and positron quantum vortex models. These two particles of spin ½ give a photon of spin 1. When looking at the frequency, the energy of the electron, which also behaves as a wave, a match to the photon frequency and energy is obtained. In other words, the experiments performed by Gauthier match the statistics of the electron to those of the photon.

Conseil Européen pour la Recherche Nucléaire (CERN) is experimenting with very small anti-hydrogen particles which are only slightly bigger than an electron-positron pair. Therefore, the experiments planned at CERN are not significantly different from what has been demonstrated with optical experiments detailed above. A number of other credible and well-executed experiments show self-acceleration—that negative mass and positive mass self-accelerate.

Using the work of Bondi (1957), we may interpret Villata's findings (2011) as negative mass of the only type compatible with general relativity. The interactions of such negative mass are given in FIG. 6. For the negative mass, the acceleration is in the opposite direction to the gravitational force.

### Experimental Evidence

For experimental confirmation of the photon's composition as two symmetrical half-photons, one of positive mass and one of negative mass, we can look to Wimmer, Regensberger et al. (2013). In their experimental setup, optical diametric drive acceleration is realized in time-domain optical mesh lattices by involving two wave packets with equal but opposite in sign effective masses. A sequence of circulating optical pulses propagating in two fibre loops connected by a 50/50 coupler form a composite beam or a wave packet, wherein there is present a length difference ΔL between the two loops. After each round trip s, pulse sequences in both loops are linearly interfered by the matrix (1/\sqrt{2})

$$( \begin{matrix}1 & i \\ i & 1\end{matrix} )$$

of the 50/50 coupler. While the positive-mass soliton (i.e. wave packet) is attracted by the negative-mass defocusing beam, the latter is constantly repelled. In other words, the positive-mass wave packet is attracted towards a smooth potential valley whereas the negative-mass wave packet is reflected from said valley. As a result, the positive-mass beam will permanently pursue its negative-mass counterpart while the latter one tries to escape. In this respect, a self-propelled bound state forms, provided that both beams exhibit identical accelerations (in the same direction). This acceleration behaviour was experimentally found to break the action-reaction symmetry. According to Newton's third law, this requires that the masses of these two constituents are equal but opposite in sign. Given that the effective photon masses in both bands of a mesh lattice have the same absolute value, the negative-mass beam should carry roughly the same number of photons as its positive-mass counterpart to achieve diametric drive acceleration. Their experimental results show the formation of such a mass/anti-mass self-accelerating state. This bound state accelerated until reaching limiting velocity Vmax. In all cases, this combined entity accelerates towards the direction of the negative-mass component. Such acceleration was considered to possibly provide a mechanism for propulsion. Furthermore, symmetrical halves of negative and positive mass on the dispersion diagram for light pulses interacting were found (FIG. 9). These light pulses propagate and interact in a nonlinear diametric drive. The upper band in the dispersion diagram has a positive curvature and therefore exhibits a positive effective photon mass that is inverse to the curvature. Alternatively, the lower band in the dispersion diagram has a negative curvature and therefore exhibits a negative effective photon mass. The light pulses also display runaway self-acceleration which is expected from FIG. 6. for the positive-negative mass interaction in which the accelerations of the two masses are in the same direction (FIG. 8).

That the photon consists of an electron with positive and a positron with negative mass explains why the rest mass of the photon is zero. Runaway motion between positive and negative mass explains why photons always travel at light speed.

In addition, the elliptical polarization of light is experimental evidence for the composite photon. This shows the electromagnetic field to be a 4-vector. The elementary photon theory predicts only two states of (circular) polarization.

For further experimental confirmation of the photon's composition as two symmetrical half-photons, one of positive mass and one of negative mass, we can also look to Pei, Wang et al. (2020). They experimentally demonstrate that a single Gaussian-like beam can self-bend during nonlinear propagation in a uniform photonic lattice. Such behaviour originates from a spontaneous separation of two components (i.e., positive and negative mass components) in the beam that experience diffractions of opposite signs under an action of a self-defocusing nonlinearity, then satisfying the condition for synchronized acceleration in a diametric-drive fashion. It is observed that initially, the two components overlap exactly. However, during the nonlinear interaction, they fail to occupy the same location. Specifically, under the self-defocusing nonlinearity, the negative index change induced by the component in the anomalous (normal) diffraction region is able to repel (attract) the part experiencing the normal (anomalous) diffraction. The part in the normal diffraction region prefers to stay at only one side of the other part, since its self-defocusing evolution is asymmetric near the inflection point, where the maximum beam tilting in the photonic lattice is defined. Consequently, they constitute a pair similar to that in a coherent diametric-drive acceleration and move jointly in a self-accelerating manner during propagation.

### Self-Acceleration and Propulsion

It is experimentally demonstrated that such self-acceleration can serve as a foundation of microscale propulsion systems. It is possible to create a continuously propulsive effect by the juxtaposition of negative and positive mass. The poles of negative mass and positive mass may be seen as negative and positive gravitational charges which create a potential gradient between them. The accelerations for positive mass and negative mass align in the same direction and a self-acceleration effect provides propulsion. Antimatter has negative mass and there is a strong gravitational force acting between matter and antimatter. This strong gravitational force is 45 orders of magnitude stronger than the Newtonian gravitational force.

Furthermore, ongoing experiments aim to generate a sizeable number of positrons, observe their behaviour and how they influence matter. Such experiments aim to establish that a sufficient quantity of positrons can push electrically-neutral materials. It is expected that a volume of positrons of the order of a cubic centimetre would be sufficient to propel a vehicle of a size of a space shuttle orbiter. Calculations suggest that a small amount of antimatter enable a massive propulsive effect.

Propulsion with Negative Mass

Pei, Hu et al. (2019) experimentally demonstrate coherent propulsion with negative-mass fields in an optical analogue, thereby renewing the picture of negative-mass propulsion proposed decades earlier. A coherent self-accelerating state is realized in a photonic lattice, driven by the interaction of its intrinsic components of positive-mass and negative-mass fields (denoted as Γ-beam and M-beam, respectively). Spacing D between said beams and beam centre shift δ are recorded and it is observed that a larger absolute value of δ indicates a stronger acceleration of the propulsion. In contrast with the behaviour encountered in traditional coherent wave interactions, the coherent propulsion shows a high immunity to the initial phase variation of the two fields. This is observed by simulating beam propagation up to sample length by employing phase differences varying from 0 to 2Π. In addition, coherent propulsion is experimentally found to exhibit an enhancement (of nearly 40 percent) of acceleration as compared with its incoherent counterpart. The observations of said experiment are suggested to bring about new possibilities for fundamental studies involving negative mass for sought-after applications based on the principles of negative-mass propulsion.

### Charges Follow a Potential Gradient

We do not find, however, that the positron of negative mass will react inversely to the electromagnetic force. This would be inconsistent with experimental evidence for the electromagnetic interaction of antimatter (Gabrielse et al. 1999). There is no gravitational potential gradient in spectroscopy experiments to determine the mass/charge ratio of antimatter particles. Since negative mass was completely unexpected, the experimental set-up, which is largely unchanged since 1897, was not designed to detect it.

When investigating the forces acting on the electron-positron pair, it is known that Centripetal force=Coulomb force=Gravitational force

For two half-photons separated by a distance

$$D = \frac{λ}{π} ,$$

wherein λ is wavelength of the photon

$$\begin{matrix}{F}_{centripetal} = 2 π \frac{c}{λ} \cdot \frac{1}{2} \cdot \frac{h}{λ} \\ = \frac{π ch}{{λ}^{2}}\end{matrix}$$

For λ=ω̅ D,

$$\begin{matrix}= \frac{π ch}{{D}^{2} {π}^{2}} \\ = \frac{ch}{{D}^{2} π} \\ = \frac{{Gm}_{e} {m}_{p}}{{D}^{2}} = {F}_{gravitational}\end{matrix}$$

wherein mₚ is mass of a positron

The strong gravitational force (Gₛ) is stronger than the Newtonian gravitational force (G) in the ratio:

$$\frac{{G}_{s}}{G} = \frac{2 {M}_{p}^{2}}{{m}_{e}^{2}}$$

Or 45 orders of magnitude stronger than the Newtonian gravitational force. In other words, a small amount of antimatter arranged with matter in an antimatter-matter dipole is capable of generating considerable force to propel a spacecraft.

### Observational Evidence for Antimatter Having Negative Mass

Composite photons consisting of particle-antiparticle pairs having positive and negative mass provide a physical interpretation at the level of particle physics for the Pair Creation Model of the Universe developed by Choi and Rudra (2104). This gives, for the first time, a fully consistent and lucid explanation of how the universe developed from net zero energy and evolved into the distribution of energy density we observe today.

The composite photon consisting of a positive mass particle and a negative mass antiparticle allows gravity to be combined with the Standard Model of particle physics for the first time.

Expansion of Einstein Field Equations to include Vector Gravity has been described in detail in Appendix 1. Furthermore, Gauss's law for gravity gives:

$$∇ . g = 4 Π {G}_{s} ρ$$

where ∇ is the divergence, g is the gravitational field and ρ is the mass density. Quantities may be positive or negative.

The APPENDIX 1 and APPENDIX 2 here provide a theoretical and experimental basis for apparatus described in the foregoing for realising practical workable embodiments of the present disclosure. Component parts of the embodiments are contemporarily commercially available and, when configured together, provide a resulting driving force to the flywheel assembly for generation of power via a turbine connected to the flywheel assembly.

1. A system for power generation, the system comprising
a flywheel assembly comprising matter therein; and
a chamber arrangement enclosure surrounding the flywheel assembly, wherein the chamber arrangement enclosure is configured to store antimatter therein using magnetic and/or electrostatic fields;
wherein the antimatter in the chamber arrangement enclosure is configured to cause rotation of the flywheel assembly, said rotation providing a driving force to the flywheel assembly for generation of power via a turbine connected thereto.

2. The system of claim 1, wherein a weight of the matter in the flywheel assembly corresponds to a negative weight of the antimatter in the chamber arrangement enclosure.

3. The system of claim 1, wherein the antimatter comprises positrons.

4. The system of claim 3, wherein the positrons are produced in copious amounts using p-doped semiconductor materials.

5. The system of claim 1, wherein the chamber arrangement enclosure is implemented as a tokamak ring-shaped chamber that is configured to store the antimatter along an annular central magnetic axis of the tokamak ring-shaped chamber.

6. The system of claim 1, wherein the system further comprises a laser arrangement, a target that is configured to be stimulated by a laser beam generated by the laser arrangement to produce the antimatter, and a deflector arrangement that is configured to guide the antimatter generated at the target into the chamber arrangement.

7. The system of claim 6, wherein the laser arrangement includes one or more Q-switched lasers that are configured to generate light pulses that cause the antimatter to be generated in the target.

8. The system of claim 1, wherein the system further comprises a particle accelerator arrangement, a target that is configured to be stimulated by a particle beam generated by the particle accelerator arrangement to produce the antimatter, and a deflector arrangement that is configured to guide the antimatter generated at the target into the chamber arrangement enclosure.

9. The system of claim 6, wherein the deflector arrangement includes one or more electromagnetic and/or electrostatic lenses for focusing the antimatter generated at the target as an antimatter beam to feed into the chamber arrangement enclosure.

10. A method of power generation using the system of claim 1.
